(19) United States
(12) Patent Application Publication
(10) Pub. No.: US 2010/0221568 A1
(43) Pub. Date: Sep. 2, 2010

(54) Silicon-Based Anticorrosive Agent

(75) Inventors: Thomas Kruse, Dortmund (DE); Gerhard Reusmann, Essen (DE); Christian Rabe, Iserlohn (DE); Bettina Werner, Wetter (DE); Holger Lewoldsen, Herdecke (DE)

Correspondence Address: BACHMAN & LAPOINTE, P.C., 900 CHAPEL STREET, SUITE 1201, NEW HAVEN, CT, 06510, US

(73) Assignee: EWALD DORKEN AG, Herdecke (DE)

(21) Appl. No.: 12/161,351

(22) PCT Filed: Jan. 16, 2007
(86) PCT No.: PCT/EP2007/000333

§ 371 Date: Aug. 22, 2008

(30) Foreign Application Priority Data
Jan. 18, 2006 (DE) 10 2006 002 545.8

(51) Int. Cl. C09D 5/10; C09D 1/02; C09D 5/08; B05D 3/12; B05D 7/14; B05D 3/00; B05D 3/10; B32B 15/04; B05C 5/00; C09K 3/00; B01F 15/04; B01F 13/06; B01F 15/06

(52) U.S. Cl. 428/560; 106/600; 106/635; 106/626; 106/14.44; 106/14.05; 427/327; 427/560; 428/457; 118/300; 252/389.31; 366/342; 366/160.1; 366/343; 366/139; 366/162.1; 366/145

(57) ABSTRACT

The invention relates to an anticorrosive agent comprising zinc dust, and a second component, an organic binder and a VOC-free or VOC-compatible solvent. In order to allow the metal workpieces to be coated in a reliable and energy-saving manner at constant quality, the binder comprises silicon dioxide and alkali silicate in a molar ratio of at least 4:1. The invention also relates to a device for mixing and metering solid and liquid components of an anticorrosive agent. Said device comprises means for metering the quantities of the respective components of the anticorrosive agent, a solution tank and a mixing device. An application system for applying the anticorrosive agent to a workpiece comprises a solution tank, feeding means, at least one pressure reducer connected to the solution tank and at least one spraying device connected to the solution tank.

The present invention relates to an anticorrosive agent with a silicon-based binder, a method for producing and for the application of the anticorrosive agent, and a device for producing and applying the anticorrosive agent.

Anticorrosive agents on the basis of zinc dust and silicatic binder have been known for a long time. They are applied as so-called zinc-dust paints either in the form of a paint coat or as a first simple anticorrosive coating, or so-called primer, on metallic raw materials or semi-finished goods, such as strip metal, metal sheeting and the like.

In both forms, zinc is used as a means for cathodic corrosion protection. However, the production, storage and processing of zinc-dust paints is not simple: zinc tends to settle and set extremely quickly, in particular in the presence of water. This is particularly disadvantageous in one-component products particularly cherished by users. One-component products therefore usually comprise organic solvents to ensure the storage capability of zinc-dust paint (DE 25 15 305; CH 503 093). In primers, the problem of poor storage capability is often also avoided by substantially reducing the proportion of zinc—and therefore the corrosion-protective effect (U.S. Pat. No. 6,468,336).

Paint coats on the basis of zinc-dust paint are applied with a high layer thickness. This layer thickness on the one hand results from the composition of the paints, on the other hand the layer thickness is an essential factor in the protective mechanism on which the corrosion protection is based. Since with zinc-dust paints a certain risk of crack formation cannot be wholly excluded over longer periods of time, the provision of greater layer thicknesses is an attempt to counteract the drawbacks resulting from crack formation. Since the zinc-dust paints are usually applied on structures in the open air (hand rails, scaffolding, bridges, stairs, ships and the like) the requirements as to the layer thickness are not of importance. As a typical example of this approach, U.S. Pat. No. 4,162,169 describes, for example, a binder suitable for the production of zinc-dust paints. The usage of zinc-dust paint covered by an impermeable top coat is described.

The binder proposed in U.S. Pat. No. 4,162,169 comprises a silane, which releases methanol when setting. It is therefore suitable for applications in the open air, or at least remote from machines or production facilities. For application in industrial facilities, the health hazards for personnel and in some cases the risk of explosion due to the methanol must otherwise be considered.

Alternatively, two-component products are available, which are mixed on site immediately prior to application. Two-component products are primarily suitable for industrial users using large amounts of zinc-dust paints. However, only small amounts of zinc-dust paint can be prepared at any one time, which then have to be processed immediately. This is why zinc-dust paints have hitherto only been suitable for applications, in particular industrial applications, where the continuous processing of zinc-dust paint is a precondition.

This approach is adopted by U.S. Pat. No. 5,888,280, wherein a two-component recipe is proposed, comprising zinc dust, a metal silicate of the IA group and a carbonate-containing internal hardener in an aqueous solution. This coating agent is not only usable as a primer, but is also considered to be suitable as a complete corrosion protection when a higher proportion of zinc particles and a reduced proportion of water is used. By releasing CO₂, the internal hardener is supposed to reduce the pH value of the coating agent and to thus accelerate hardening.

Further, attempts are being made to improve the corrosion protective effect of zinc-dust paints, amongst other things, by suggesting the use of conductive substances, such among others iron phosphide or iron oxide compounds in combination with zinc-dust paints. A typical example of this development is shown in U.S. Pat. No. 6,468,336.

It is an object of the invention to provide an anti-corrosive agent with which metallic workpieces can be coated with uniform quality in a continuous, safe and energy saving manner. Herein, the present invention in particular aims at the use of binders which release as little as possible or no organic components (VOC: volatile organic components) during processing of the zinc-dust paint. The precondition for a VOC-free and VOC-conform coating agent to which the present invention also refers, is defined in the 31^{st} BIMSCHV (Bundes-Immisionschutz-Verordnung—“German Law Concerning the Protection against Harmful Effects on the Environment through Air Pollution, Noise, Vibrations, and Similar Factors”) of Aug. 21, 2001 (BGBl. (Federal Law Gazette) I, No. 44, of Aug. 24, 2001, p. 2180).

The object is solved by an anticorrosive agent according to claim 1, a method for coating workpieces according to claim 19, a workpiece with an anticorrosive agent according to claim 26, a method for producing an anticorrosive agent according to claim 30, a device for producing an anticorrosive agent according to claim 38 and an application arrangement according to claim 46.

According to the present invention, the anticorrosive agent comprises two components. A first component is essentially comprised of zinc dust, if necessary with an added anti-settling agent. The weight proportion of the first component is, relative to the overall recipe, at least 40 weight %, preferably at least 60 weight %, particularly preferably at least 80 weight % to a maximum of 97 weight %. The high percentage of zinc dust ensures a corrosion protection hitherto unheard of for zinc-dust coatings.

The zinc-dust particles have an average particle diameter of up to 10 μm, preferably of up to 8 μm. With this particle size, the ratio between the diameter and the specific surface of the particles is optimal for the dry-film thicknesses to be established with these particles.

If necessary, agents are added to the zinc dust, which prevent undesirable compacting of the zinc dust, so-called anti-settling agents. Zinc oxide or amorphous SiO₂ is particularly suitable, for example. The proportion of the anti-settling agent in the first component can be up to 15 weight %, preferably up to 10 weight %, particularly preferably up to 5 weight % relative to the amount of zinc dust. The use of zinc oxide has turned out to be surprisingly advantageous in spraying the anti-corrosive agent, since zinc oxide contributes to improved spraying behavior. The nozzles of the spraying device tend to clog much more rarely when zinc oxide is used. The proportion of zinc oxide indicated, takes into account that zinc dust comprises 1 to 3 weight % zinc oxide due to manufacturing conditions.

A second component is composed of an inorganic silicon-based binder, a VOC-free or VOC-conform solvent and, if necessary, particles contributing to improving the corrosion protection. In particular, alkali metal silicates with added silicon dioxide have proven suitable. A binder is preferred in which the proportion of silicon dioxide is greater than the proportion of the alkali oxide (the alkali silicate here is calculated on the basis of alkali oxide). The ratio of SiO₂ to alkali oxide is at least 4 to 1, preferably at least 5 to 1, particularly preferably 6 to 1.

For adapting to various application purposes or processing conditions, mixtures of alkali metal silicates can also be used, such as for example a mixture of sodium and potassium silicates, or alternatively lithium silicates.

Depending on the requirements of the particular application, co-binders can be added to the binder. These are preferably polymeric binders, such as methyl silicone resin or non-saponifying acrylates. Such binders can serve to adjust the hardness or the elasticity of the binder, for example.

The proportion of the binder in the second component is at least 3 weight % to a maximum of 40 weight %, preferably between 10 and 20 weight %.

As VOC-free or VOC-conform solvents, either water, high-boiling solvents or mixtures thereof can be used. VOC-conform solvents, are those solvents in particular, which have a boiling point (above 250° C.) which is sufficiently high so that no organic substances are released during processing. For reasons of working safety, the use of water as a solvent is preferred. Water also ensures that the anticorrosive agent is VOC-free.

The usual well-known pigments are usable for the anticorrosive agent. In practical application, however, the achievement of a uniform, high-grade metallic appearance of the coated workpieces is often desired. This is why metallic particles are often added to the anticorrosive agent. Particles of passivated aluminum, which are used solely to contribute to the optical appearance of the surface, are particularly suitable. Aluminum can be used in various forms. The use of passivated aluminum flakes as a solid which is added, if necessary, to the second component, is preferred. Depending on the requirements of each anticorrosive agent, particles for improving the anticorrosive effect can also be stored as a third component, which is combined with the first and the second component during the production of the anticorrosive agent, such as when the aluminum particles are present as an aqueous paste.

The pigments are added to the second component of the anticorrosive agent in an amount of at least 5 weight % relative to the overall amount of the second component. Preferably at least 10 weight % to at least 15 weight %, particularly preferably up to 20 weight % pigments are added.

Further additives can be added to the anticorrosive agent, either in the first component or in the second component, in order to adapt the anticorrosive agent to the processing conditions or to ensure predefined usage behavior. Agents for adjusting the sliding behavior or lubricants are referred to here, in particular. They are preferably added to the second component, however, they can also be contained in the first component.

Solid or liquid waxes in the form of an emulsion or dispersion can be added as additives to the coating agent according to the present invention, to adjust the sliding behavior of the coating, for example. The usual and well-known waxes can be used, such as waxes on the basis of polyethylene or polypropylene, polytetrafluor ethylene, but of course also natural waxes, such as carnauba wax, or mixtures of the previously mentioned substances. Other substances influencing the lubrication and sliding properties, such as graphite, molybdenum disulfide or boron nitride, can also be used as additives. The usual amounts of lubrication or sliding agents used, are up to 20 weight %, preferably up to 5 weight %, advantageously up to 3 weight % relative to the overall recipe of the anticorrosive agent.

In addition to the binder according to the present invention, the coating agent can also contain additives which influence undersurface wetting, defoaming, flow behavior, degassing or pigment wetting, as well as agents for flexibilizing or catalysts. These additives can each be added in proportions between 0.01 and 8 weight % in relation to the overall formulation of the coating agent.

Within the scope of the present invention, water-dispersible or mixable corrosion inhibitors, preferably nitrogen containing compounds, in particular quaternary ammonium salts can be added to the second component with a good effect. Further preferred additives for the coating agent are boron compounds, in particular from the group of boron acids or boron oxides, but also molybdenum compounds or phosphorous containing compounds. These corrosion inhibitors are added in an amount of 0.01 weight % to 30 weight % in relation to the overall formulation, wherein the lower threshold is predetermined by the achievement of a desired effect, while the upper threshold is given by cost considerations.

The anticorrosive agent according to the present invention has a pH value between 6 and 12, preferably between 8 and 12. The alkaline adjustment of the anticorrosion agent alone contributes to the protective effect of the base coat on the workpiece, because the alkaline environment which is established by the presence of water counteracts corrosion. As a particular advantage it has to be noted that an anticorrosive agent having a pH value of between 10 and 12 hardly passivates the zinc contained in component 1 (cf. B. Roathali, G. Cox and W. Littreal, “Metalls & Alloys”, 3.73, 1963) so that a maximum of cathodically effective zinc particles is contained in the coating.

The anticorrosive agent according to the present invention ensures an extraordinarily efficient and durable rust protection unlike well-known zinc-dust paints. A coating having a dry-coat thickness of 10 μm ensures a useful life in the salt spray test according to DIN 50 0 21 of at least 200 hours, with double the coating thickness of the dry layer, the useful life is at least 500 hours. The corrosion protection achievable therefore greatly surpasses all the values hitherto attained. This is why the application range for the anticorrosive agent according to the present invention extends far beyond the use as a simple paint coat. The anticorrosive agent can be applied to the metal surfaces to be coated using various application methods. Due to the high effectivity even with very thin layer thicknesses, the agent is very economical and cost-saving.

According to a particularly preferred embodiment, the anticorrosive agent according to the present invention is suitable for being coated with another layer, in particular a coloring coat. Such a coat, which adheres to the anticorrosive agent according to the present invention without impeding its properties, a so-called top coat, is comprised, for example, of the same binder which is contained in the second component of the anticorrosive agent. Here, again, the binder can be complemented by a co-binder, preferably a polymeric co-binder, in particular a methyl silicone resin or a non-saponifying acrylate.

According to a further preferred embodiment, this top coat is provided with coloring pigments, such as aluminum pigments, carbon black or iron pigments. The top coat can be VOC-conform, that is contain limited amounts of organic substances, which are released during processing or hardening of the top coat. Preferably, however, the top coat is also VOC-free.

To also enable sensitive materials to be coated, the anticorrosive agent and, if necessary, also the top coat are preferably adjusted in such a way, that drying or hardening can be at temperatures of up to 120° C., preferably up to 80° C., particularly preferably up to 40° C.

Another object of the present invention is to provide a method for applying an anticorrosive coating on a metallic workpiece. This method is considered to be an independent inventive aspect of the present invention.

The method according to the present invention for coating metallic workpieces provides for cleaning the surface of the metallic workpiece, if necessary, then coating with a (preferably) VOC-free or VOC-conform primer, coating the workpiece after drying of the primer with an anticorrosive agent according to at least one of claims 1 to 10, and finally drying the anticorrosive agent.

Applying the primer, which in the most simple case comprises a water glass solution or a co-binder, as described for the anticorrosive agent, improves the adhesion of the anticorrosive agent on the workpiece and therefore ensures long lasting corrosion protection of the workpiece.

Cleaning the workpiece will usually be necessary, because residues of previous processing steps prevent the adhesion of the anticorrosive coating. Basically, any type of surface cleaning is suitable for creating a ground surface for the coating according to the present invention. It is important to note, however, that even mild cleaning methods, such as those required for the preparation of sensitive materials, also provide a suitable ground surface for the above mentioned coating with anticorrosive agents. In particular, cleaning of temperature and/or acid sensitive materials, such as special steels, by means of brushes, ultrasonic waves, an alkaline and/or solvent bath or vapor cleaning, or a sequence or combination of these cleaning steps creates surfaces suitable for coating.

A primer is applied, at least in parts, to the thus cleaned surface of the workpiece. Numerous primers are suitable, such as co-binders, which can be used with the binder of the anticorrosive agent or of the top coat. Preferably the primer is a VOC-free solution, for example a 4% water glass solution, containing additives, if necessary, which is unproblematic to process. In the most basic case, the primer can be applied without further additives, however, it usually has further additives, such as wetting agents and corrosion inhibitors, if any, added to it. Preferably up to 5 weight % wetting agent and/or anticorrosive agent is used, advantageously up to 0.05 weight %. This coating is then dried. Drying is done by means of air drying, preferably between room temperature and 100° C., which is particularly simple and cost-effective. The layer thickness of the dried primer is between 100 nm and 3 μm.

According to the present invention, a layer of the above described anticorrosive agent is at least partially applied to the dried primer. The anticorrosive agent can be applied with the aid of any desired application method, in particular spraying, rolling, casting, brushing, raking, roller application, dip-centrifuging or dip-drawing. Suitably, coating with the anticorrosive agent is done immediately after drying the primer, but not later than four hours thereafter, to ensure optimum long lasting corrosion protection. The anticorrosive agent is touch-dry at room temperature after a short time, and it is tack-free after about 30 to 120 seconds on the surface of the workpiece. Depending on the binder and the layer thickness, and on the proportion of the zinc dust, the actual hardening time is between 24 hours and 72 hours, in extreme cases, hardening time can be up to 14 days.

The temperatures required for drying both the primer and the anticorrosive agent are not above 120° C., preferably not more than 80° C., particularly preferably not more than 40° C., advantageously not above room temperature. Drying or hardening can be with the aid of air both for the primer and for the anticorrosive agent. Preferably, drying is carried out with strongly increased air velocity, which is generated, for example, in so-called lateral compressors. This form of drying only requires little energy expenditure and comparatively small apparatus.

The workpiece coated according to the above described method has long lasting corrosion protection even if it is exposed to aggressive environmental conditions. The above described coating with primer and an anticorrosive agent is extremely suitable, for example, for coating brake disks, which have to last in a salt spray test for more than 500 hours. Brake disks have hitherto been coated with well known anticorrosive agents, which have to be heated to temperatures above 300° C. over longer periods of time for complete hardening. Herein, the brake disks are often deformed, which is unacceptable for these products. Well known coatings therefore lead to a relatively high number of rejects. Other components are made of temperature-sensitive metal or cast, for example. These materials change their properties substantially when they are heated above 180° C. This is why conventional coating methods are unsuitable for a large range of anticorrosive agents, which still need temperatures of above 160° C., often above 200° C., for hardening of the coating. The anticorrosive agent according to the present invention provides substantially improved possibilities for extensive cathodic corrosion protection.

For the workpiece according to the present invention, a dry coating thickness of the anticorrosive agent after hardening of 1 μm to 100 μm, preferably between 15 μm and 60 μm, particularly preferably of between 20 μm and 40 μm, is aimed at.

The anticorrosive agent comprising 2, or 3 components, as the case may be, can be prepared ready for use in a particularly simple manner. It is well known from the state of the art that zinc dust is mixed into the binder. This coating agent must then be processed immediately. Due to the extremely short processing time (pot life) the well known products always have to be processed in batches.

This type of preparation of the anticorrosive agent is unsuitable for industrial processing. A supply of anticorrosive agent according to the present invention better suited to meet continuous demand has hitherto not been available, however. Tests have shown that a quasi-continuous production of anticorrosive agent by the user is best suited to meet continuous demand.

On the basis of the above-mentioned object, the method explained below is provided as an independent aspect within the scope of the approach of the present invention for the production of coating agents with solid and liquid components.

For this purpose, first, a portion of the liquid components of the anticorrosive agent is put in a preparation vessel for preparation of the coating agent. As initially mentioned, the liquid components can be, for example, the liquid component of the coating agent with binders and further additives, such as adhesion promoters, wetting agents, thickeners, defoamers, degassing agents, pigment wetting agents, corrosion inhibitors, but also agents for flexibilizing or catalysts. A suitable solvent or water can also be provided.

Next, the solid component is added, and a homogenizing phase is carried out for uniform mixing of solid and liquid components.

“Solid components” in the context of the present invention, are particulate materials, such as metal particles/flakes, dried pigments and fillers, in particular. Also paste-like components, that is, those which only have very limited flow properties, are interpreted as solid components in the context of the present invention.

After homogenizing the preparation for the coating agent, the remaining amount of liquid component is added and—depending on the viscosity of the individual components—is, if necessary, mixed with the preparation.

According to a particularly preferred embodiment, the metering and mixing of the solid and liquid components is automatically controlled. This control, according to an advantageous embodiment, also controls that optimum process parameters, such as the temperature, pressure, mixing duration and intensity of mixing, are adhered to.

The method is advantageous, in particular, for the production of coating agents having a high proportion of solid components, such as the anticorrosive agent according to the present invention. The method allows a quasi-continuous supply of anticorrosive agent according to the present invention, for example, within industrial production processes. While preparation of an anticorrosive agent is carried out in a batch, a supply of anticorrosive agent in a continuous industrial process, such as within a coating plant in a production line, is possible because of the unique, preferably automated, form of the method. It is possible to produce particularly uniform preparations with an exceptionally high proportion of solid component in an economical manner, even if VOC-free or, as the case may be, VOC-conform components are exclusively relied upon.

The determination of the portion of the liquid components which is put into the vessel at the beginning of the method basically depends on the ratio of the liquid to the solid components, and in particular on the viscosity of the liquid components. The portion should be chosen such that during the homogenizing phase a homogeneous paste of mean to high viscosity is obtained, whereby good mixing is achieved by having the viscosities of the individual components approach each other. For production of the anticorrosive agent according to the present invention with an exceptionally high proportion of zinc dust (for example above 90 weight %) and a VOC-conform solvent, the portion is preferably about a third of the overall amount of the liquid components. Here a separation of agglomerated zinc particles is achieved as well as excellent homogeneousness.

Depending on the condition of the liquid components, in particular, the preparation is regularly mixed preferably during adding of the solid components and/or during the homogenizing phase. Herein, basically all suitable devices and methods may be used, such as, for example, mixing by gas vortexing or continuous or regular circular pumping of the preparation. It is particularly preferred that the preparation be stirred regularly or continuously. Herein, the usual stirring devices, depending on the size of the preparation vessel, such as magnet stirrers, dissolver disks or an Ultraturrax may be used. To prevent settling of the solid components in the coating agent, it is further preferred that the preparation be regularly mixed also during adding of the remaining amounts of the liquid components and during any subsequent waiting or stirring time.

During stirring of the preparation, the quality of the mixing process is determined by the selection of the stirrer and the stirring speed. On principle, the stirring speed should therefore be selected with reference to the circumferential velocity as a function of the materials to be homogenized. Experimental results of the applicant confirm, for example, that a speed of between 100 and 1500 rpm, and preferably 1000 rpm, is particularly advantageous when a dissolver disk is used for producing a coating agent. Particularly preferably the speed is adjustable, so that different speeds may be set for the individual method steps.

Preferably the temperature of the coating agent preparation is kept between 4° C. and 40° C. during the method. For this purpose the preparation vessel may be configured in a suitable way, for example, with the usual heating and cooling devices. Double-walled preparation vessels, in which a heating or cooling medium flows, are particularly suitable. Depending on each binder system, it may be suitable to apply a predetermined overpressure or partial vacuum to the vessel during the mixing and dosing method. By applying a vacuum, in particular, defoaming and therefore good homogenization of the coating agent can be achieved, for example. The preferred partial vacuum is about bar below atmospheric pressure.

According to a further embodiment of the present invention it is preferred to add further solid and/or liquid components and in particular solid and/or liquid additives together with or after the addition of the remaining amount of the liquid components. For example, pigments, in particular metal particles and/or flakes, such as aluminum flakes, in solid or paste-like form, but also lubricants, wetting agents, thickeners or adhesion promoters, as described above in the context of the composition of the anticorrosive agent, can be added. Depending on each additive, mixing or stirring of the coating agent preparation should also preferably continue during the addition of additives and/or thereafter. Stirring after completion of the coating agent, is preferably at a speed in the area of up to 500 rpm.

Due to the special recipe of a VOC-conform anticorrosive agent and due to the special production method used therefor, in the context of the approach according to the present invention, a device for mixing and dosing solid and liquid components of the anticorrosive agent is provided as an independent aspect for producing the anticorrosive agent according to the present invention. This device is provided with means for measuring the amounts of each component of the anticorrosive agent, a preparation vessel and a mixing device and means, if necessary, for controlling the method. The use of such a device enables the above mentioned method for producing the anticorrosive agent according to the present invention to be carried out easily.

For measuring the amounts of each component of the anticorrosive agent, basically all the usual devices, such as weighing machines, pumps or flow-through meters are suitable. For example, the solid components, such as zinc dust, can be added in a dosed manner by means of weighing the anticorrosive agent preparation. Herein, the preparation vessel can be arranged on a weighing device, for example, so that the weight of the preparation vessel can be determined. Before adding each amount, the weight of the preparation vessel is determined and the difference of each measuring value is determined during the addition of the component. For adding liquid components, clocked pumps or flow-through meters/sensors for measuring the amounts can also be advantageous. A weighing machine can also be used for liquid components. The measuring unreliability should not be more than 2%, preferably not more than 1%, so that the recipe of the anticorrosive agent according to the present invention can be adhered to. The choice of each device for measuring depends on the respective conditions of the substrate to be measured.

The device for mixing the anticorrosive agent further has a preparation vessel for receiving the anticorrosive agent preparation, and a mixing device. The preparation vessel should be easily exchangeable, if possible, so that it can be used in an industrial production process in a quasi-continuous operation. Advantageously it is possible to use the preparation vessel after producing the anticorrosive agent directly in an application or coating arrangement.

According to a further embodiment of the invention, the preparation vessel is a pressure vessel. Depending on each application device or when using volatile components within the anticorrosive agent, a pressure vessel is advantageous. Preferably, the device comprises means for keeping the vessel temperature of the preparation vessel constant. By these means, the required temperature range can be maintained even with exothermally reacting solvents or binder systems. To achieve this, the preparation vessel can have a double-wall configuration, wherein a cooling liquid or water can flow through the cavity resulting between the two vessel walls. With the use of a usual heating or cooling unit, tempering of the preparation can be carried out.

The mixing device should be configured such that regular or preferably continuous mixing of the anticorrosive agent preparation can be achieved in the preparation vessel. Suitable mixing devices can be configured in such a way, for example, that gas nozzles arranged on the preparation vessel vortex the anticorrosive agent preparation by applying a suitable gas pressure. It is also conceivable to remove the anticorrosive agent preparation from the preparation vessel and to add it to the preparation vessel again in a closed circuit by a pump (circular pumping).

Preferably the mixing device is a stirring device. Corresponding stirring devices usually have a stirrer, such as a dissolver disk, or a spiral stirrer, which are movable by a suitable drive. The drive can be, for example, an electric motor. It is preferred, in particular, for the stirrer to be configured such that mixing can be carried out both in the plane of the stirrer and vertical thereto. With such a stirring tool, particularly in the mixing process of anticorrosive agents with a high concentration of solid components, good mixing results can be achieved. The stirrer should further be preferably adapted to the geometry of each preparation vessel.

For further improving mixing of the anticorrosive agent preparation, it is further preferred for the preparation vessel to have the usual swirling means, such as chicanes on the inside.

In a further embodiment of the invention, conveying means are provided for conveying a solid or liquid component from each reservoir into the preparation vessel. In industrial production lines, in particular, at least partially automated mixing and dosing of the components of the coating agent preparation is advantageous. Since furthermore the tolerances for the individual components are usually relatively small within one recipe, dosage errors can thus be avoided. It is generally preferred to convey all components of the coating agent by means of conveying means into the preparation vessel. To enable improved dosage, the conveying power of the conveying means should preferably be adjustable.

Each conveying means is configured in dependence on the component to be transported. For liquid components, pumps with tubular or hose-like conduits are usually advantageous. For dry and paste-like components of the coating agent, preferably a worm conveyer is used. In particular for the use of metallic particles, such as ultra-fine zinc dust, dosing is often very difficult and involves high amounts of health-hazardous emissions due to the low weight of the particles and their high atomizing tendency. This is why worm-conveyers are particularly advantageous. Further it is also conceivable to add solid particulate components and in particular metal particles, such as zinc dust, by means of pressurized air supplied through conduits into the preparation vessel. In particular for paste-like components, the conveying means can also suitably be a pressing-out device.

Preferably the device for mixing and dosing comprises control means for controlling the dosage. Such control means facilitate secure and precise dosage. It is, of course, also possible for the control means to monitor and adjust further process parameters, such as mixing, by measuring viscosities appropriately, in addition to controlling the dosage. The control means can also be configured such that they automatically monitor the pot life depending on the settling behavior of the anticorrosive agent and are thus integrated in the process control of an application or coating plant. It is also conceivable to provide means for monitoring the filling level, so that when a particular filling level falls below a particular threshold within the application or coating plant, mixing of a new anticorrosive agent preparation is automatically started in the device for mixing and dosing. Control means are commercially available in process technology, wherein SPS controls or microprocessor controls are particularly suitable, for example.

As mentioned above, the application of the anticorrosive agent according to the present invention is difficult because of the properties of the VOC-conform anticorrosive agent with respect to its settling behavior and short drying period. For this reason conduits and devices can easily clog. Due to this particular problem in the processing of the VOC-conform anticorrosive agent according to the present invention, an application arrangement for applying anticorrosive agent on a workpiece is provided as an independent aspect for providing an anticorrosive coating within the context of the approach according to the present invention. The application arrangement therefore comprises a preparation vessel, conveying means, at least one pressure reduction regulator connected to the preparation vessel, and a spraying device connected to the preparation vessel.

With such an arrangement it is possible to apply the anticorrosive agent according to the present invention on a workpiece in an advantageous way. The preparation vessel should be configured in such a way, that processing in batches within the pot life of each anticorrosive agent composition is possible. The size of the preparation vessel should therefore be chosen according to the requirements of each coating plant.

It is conceivable to use the same preparation vessel within the device for mixing and dosing and the application arrangement. The preparation vessel should have suitable ports for removing the anticorrosive agent. For this purpose, the application arrangement has suitable conveying means, for example, all the usual conveying means, such as suitable feed pumps, can be used. Such conveying means should be configured in such a way that the usually present conduits between the preparation vessel and the pressure reducer/spraying device can be supplied with anticorrosive agent under a suitable operating pressure. The operating pressure should basically be chosen as a function of the relevant conduit length. For the usual coating plants, an operating pressure of between 1 and 2 bars has proven suitable. In particular, the operating pressure should not be chosen too small to avoid settling of the solid components of the anticorrosive agent or clogging of the conduits. An HVLP method is particularly preferred for applying the anticorrosive agent on a workpiece. This is why it is necessary to set a precise spraying pressure, usually between 0.3 and 0.4 bar. To adjust the corresponding spraying pressure, a pressure reduction regulator is provided. The pressure reduction regulator should be able to safely regulate the operating pressure caused by each conveying means. Preferably, the pressure reduction regulator is interposed between the preparation vessel and the spraying device connected therewith. When a plurality of spray guns is used in one application arrangement, a pressure reduction regulator should be provided for each spraying device to be able to optimally adjust the spraying pressure at each spray gun. Herein, the conduit path between the pressure reduction regulator and the spray gun should be as short as possible. Such pressure reduction regulators are commercially available in the field of fluid technology. The pressure reduction regulator and the spraying device should be configured in such a way that clogging during operation is avoided.

For this reason the pressure reduction regulator has a contact-free configuration, i.e. the pressure reduction regulator is not in immediate contact with the anticorrosive agent used in operation. Such a configuration of the pressure reduction regulator is advantageous, in particular, since the usual membrane pressure reduction regulators have a tendency whereby, with the coating agent according to the present invention having solid and liquid components, portions of the solid components accumulate within the pressure reduction regulator and thus lead to untimely clogging of the pressure reduction regulator. It is therefore preferable, in particular, if the preparation vessel is at least partially connected with the spray gun by means of a hose conduit, and that the pressure reduction regulator is configured in such a way that the cross section of the hose conduit is at least partially variable. By means of such a configuration simple pressure regulation is possible. The pressure reduction regulator can squeeze the hose conduit, for example, by means of a pneumatic cylinder. The hose conduit should therefore be configured corresponding to the form of the pressure reduction regulator, and should be elastic, in particular. A hose is preferably used which has an inner diameter of between 2 mm and 10 mm.

Particularly preferably, the spraying device is configured in such a way that the atomizer air flow generated in operation atomizes the anticorrosive agent outside of the spraying device. Thus, the anticorrosive agent advantageously only comes into contact with the atomizer air flow outside of the spraying device. The spraying device is configured correspondingly, wherein the nozzle, in particular, can have an adjustable opening size. Corresponding tests of the applicant show that a nozzle size of between 0.5 mm and 1.2 mm, in particular, is advantageous with the use of a star-shaped nozzle (“Stern-S”). Any other suitable nozzle can of course also be used.

Apart from the atomizer air flow, a shaping air flow is also provided outside of the spraying device, for providing the remaining amount of air necessary for atomizing the anticorrosive agent and for forming the spray jet.

Such a configuration of the spraying device is advantageous, in particular, with the anticorrosive agent according to the present invention, since it quickly hardens when brought into contact with air. The amount of air necessary for atomizing is essentially added outside of the spraying device, as a result of which clogging of the spraying device can be advantageously avoided.

According to a preferred embodiment, the preparation vessel comprises a mixing device, even if it is used in the application arrangement. Depending on the composition of the anticorrosive agent, it may be advantageous to regularly mix or continuously mix the anticorrosive agent preparation present in the preparation vessel. This helps to advantageously avoid premature settling, in particular, with anticorrosive agent compositions having a high proportion of solid components, such as the VOC-conform anticorrosive agent of the present invention. Corresponding mixing devices to be used for this purpose have already been discussed in the explanation of the device for mixing and dosing, to which reference is made.

It is preferred, in particular, if the preparation vessel used in the application arrangement is a pressure vessel and has a device for continuously stirring the anticorrosive agent. By configuring the preparation vessel as a pressure vessel, it is possible to apply the operating pressure to the entire vessel by means of suitable conveying means, such as pressurized-air supply. When pressurized air is used as a conveying means, the preparation vessel should have a corresponding pressurized-air supply. For easy access to the inside of the preparation vessel, such as during the mixing and dosing process of the anticorrosive agent, the preparation vessel should have a removable lid. The device for continuously stirring the anticorrosive agent can comprise, for example, a spiral stirrer for mixing the anticorrosive agent. A drive can be, for example, by means of an electric motor, which is preferably arranged externally of the preparation vessel. In this case, however, pressure tightness of the preparation vessel must be ensured by means of corresponding seals.

In a further embodiment, the means for pressurizing comprise a pump between the preparation vessel and the spraying device, in particular a double-membrane pump is preferred. For pressure regulation, a pressure reduction regulator should be arranged between the pump and the spraying device. A recirculating conduit is arranged between the pump and the pressure reduction regulator and forms a recirculating conduit to the preparation vessel. When the application system is arranged in such a way it is not necessary to configure the preparation vessel as a pressurized vessel. The pump between the preparation vessel and the pressure reduction regulator provides the necessary operating pressure in the corresponding conduits. The recirculating conduit which is preferably arranged in the vicinity of the pressure reduction regulator and the spraying device, connects the conduit between the pressure reduction regulator and the pump in turn with the preparation vessel. Through this at least part of the anticorrosive agent is circulated, which serves to continuously mix the anticorrosive agent within the preparation vessel (circular pumping). Preferably, the under-level method is used, wherein the recirculating conduit is connected to the preparation vessel in such a way that the recirculating anticorrosive agent is recirculated below the level of the anticorrosive agent present in the preparation vessel.

For industrial production it is particularly advantageous if the application arrangement for applying the corrosion protection comprises a device for mixing and dosing, as mentioned above. The combination of a device for mixing and dosing and the application arrangement allows a batch operation to be carried out by exchanging each preparation vessel. Herein, it is not necessary that a device for mixing and dosing is present for each application arrangement in a production line, rather, it can be suitable from an economical point of view, to provide an device for mixing and dosing for a plurality of application arrangements. By combining the two devices it is possible in an advantageous way to use only one preparation vessel for each preparation of anticorrosive agent. The anticorrosive agent can be produced directly in the device for mixing and dosing within the preparation vessel, which is subsequently used within the application arrangement for applying anticorrosive coatings on workpieces.

Herein it is immaterial whether the application arrangement and the device for mixing and dosing are in close spatial vicinity or are at a certain distance from each other, for example in different plant facilities. However, it is possible for the application arrangement and the device for mixing and dosing to be controlled and regulated by a common process control. For example, a device for measuring the filling level within the preparation vessel can be arranged within the application arrangement, and when a filling level falls below a certain threshold, a new preparation of anticorrosive agent can be produced in another preparation vessel within the device for mixing and dosing.

The invention will be explained in the following in further detail with reference to exemplary embodiments. In the drawings:

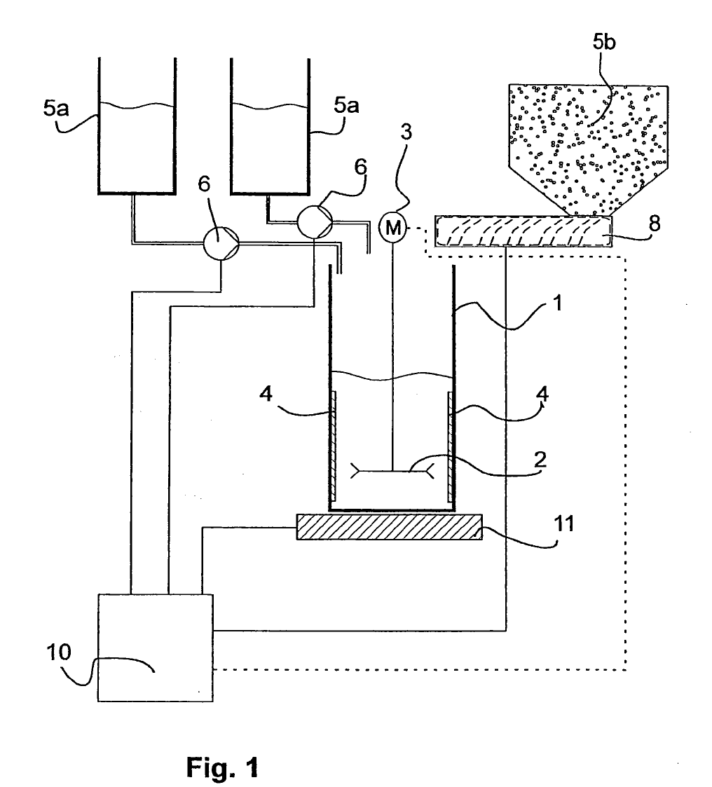

FIG. 1 shows a first exemplary embodiment of a device for mixing and dosing solid and liquid components of an anticorrosive agent;

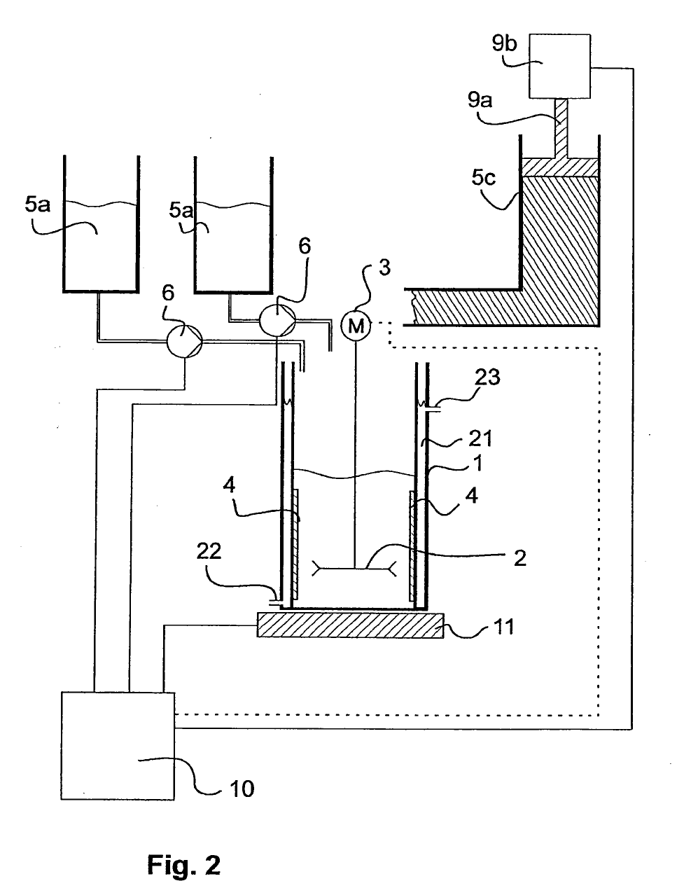

FIG. 2 shows a second embodiment of the device for mixing and dosing;

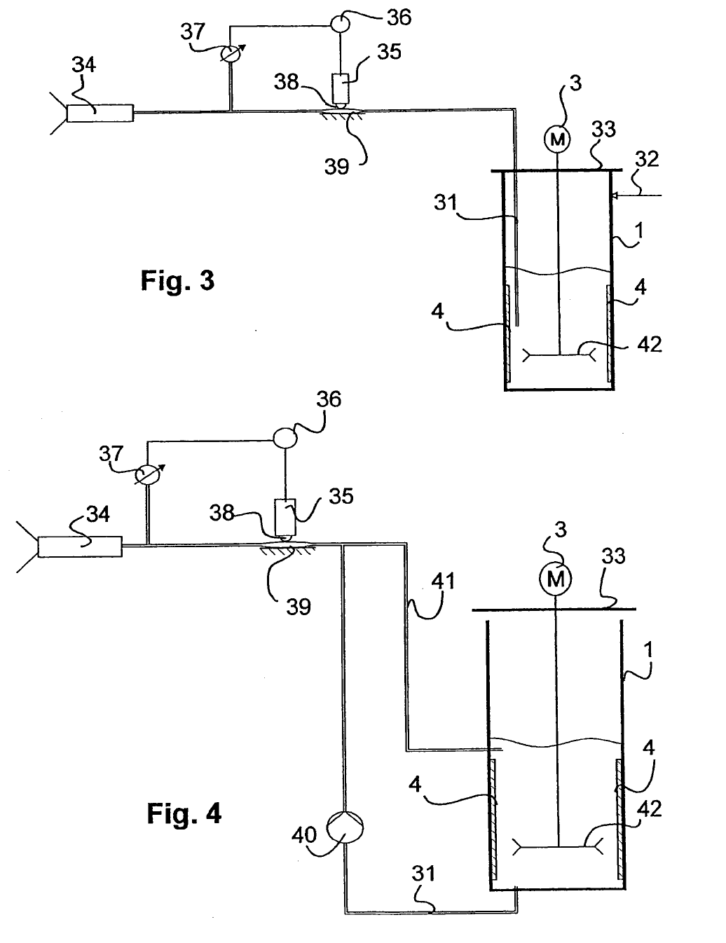

FIG. 3 shows a first embodiment of an application arrangement for applying anticorrosive agent on a workpiece;

FIG. 4 shows a second embodiment of the application arrangement; and

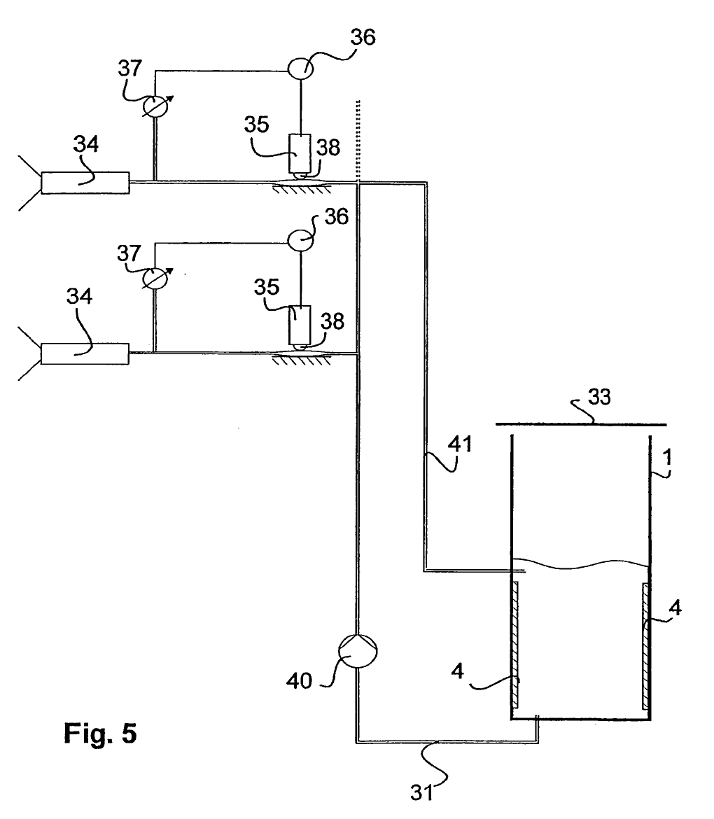

FIG. 5 shows a third embodiment of the application arrangement.

### ANTICORROSIVE AGENT, EXAMPLE I

First, details of the production of the anticorrosive agent for a selected exemplary embodiment will be explained: 55 g zinc dust having an average particle diameter of 8 μm and 10 g zinc oxide of the same diameter are mixed and separately stored as component I in the form of a dry and frost-free powder. Component II comprises 25 g of a binder of potassium silicate and silicon dioxide (SiO₂), wherein the mole ratio of SiO₂ to potassium oxide is 5:1. Further, 0.05 g of a thickener and 1 g each of further additives, such as Kelzan ST®, a wetting agent, such as Tego Wet 500® and a 20% aqueous solution of tetraethyl ammonium hydroxide (TEAH) are added as a stabilizer. 7 g of deionized water is added to the second component. The ingredients of the second component are mixed by a stirrer for 15 minutes. The component II has a pH value of above 11. It is VOC-free. The component is stored in a usual closed container.

### ANTICORROSIVE AGENT, EXAMPLE II

An alternative embodiment of the anticorrosive agent has the following ingredients: Component I: 60 g zinc dust, containing up to 3 g zinc oxide due to manufacturing conditions. Component II: 20 g of the binder from example I, 0.05 g of a thickener, such as Kelzan ST® and 1 g each of a wetting agent, such as Tego Wet 500® and a 20% aqueous solution of tetraethyl ammonium hydroxide (TEAH) as a stabilizer and 10 g of a 60% aqueous aluminum paste and 8 g of deionized water. The anticorrosive agent according to example II is produced by first stirring the aluminum paste for at least 30 minutes. Hereafter, the ingredients of component II are mixed by a stirrer. The component II has a pH value of above 11. It is VOC-free. The component is stored in a usual closed container.

### EXEMPLARY EMBODIMENT, WORKPIECE

Brake disks of steel are coated with the anticorrosive agent according to the exemplary embodiment II. The brake disks have previously been cleaned of dust and grease. A VOC-free solution containing 4% water glass is sprayed onto the brake disks. The brake disks coated with primer pass through a blower. This is for drying the primer coat (layer thickness 1 μm) at room temperature. On top of the primer layer, the anticorrosive agent according to the exemplary embodiment II is sprayed in a layer having a thickness of 50 μm. Coating is carried out at room temperature. Subsequently, the coated brake disks pass through a continuous drying furnace, in which a high air velocity is generated by means of lateral compressors, which results in the anticorrosive agent drying and hardening on the brake disks within a short time. Drying at elevated temperatures is not necessary.

In the salt spray test, a useful life of more than 500 hours is measured for the thus coated brake disks. The brake disks could be coated without warping of the brake disks due to heating. By adding passivated aluminum particles in the anticorrosive agent, the brake disks have an attractive uniform color.

FIG. 1 shows a first embodiment of a device for mixing and dosing solid and liquid components of an anticorrosive agent. The device has a preparation vessel 1, having a stirring device for mixing the components. The stirring device comprises a dissolver disk 2 and is driven by an arrangement comprising an axle and an electric motor 3. The electric motor 3 is mounted outside of preparation vessel 1, on the latter or on the vessel lid (not shown). Preparation vessel 1 is of steel and has lateral chicanes 4, which are for improved mixing results vertical to the plane of dissolver disk 2, in particular. Alternatively it would be conceivable to use a dissolver suction disk instead of dissolver disk 2.

The device for mixing and dosing further has one or more reservoirs 5a for liquid to paste-like components of low to mean viscosity. For example, the solvent (here: water) and the binder are stored in such reservoirs. The dosage of these components in preparation vessel 2 is carried out by pumps 6. These can be commercially available impeller pumps. Depending on the component used, double-membrane pumps can also be used. For the case that a paste-like component has to be dosed by means of a pump 6, it should be adapted to the material properties of each component. For dosing solid components of the anticorrosive agent, such as zinc dust, the device for mixing and dosing has at least one reservoir 5b, the dosage of solid components being carried out by a worm conveyer 8.

For controlling the dosage, a microprocessor unit 10 is provided, which is connected with pumps 6 and worm conveyer 8. Further, preparation vessel 1 is continuously weighed by a precision weighing machine 11. By evaluating the measuring data of precision weighing machine 11 in microprocessor unit 10, pumps 6 and worm conveyer 8 are controlled in a clocked manner on the basis of the anticorrosive agent recipe so that the corresponding proportions of the components of the anticorrosive agent can be precisely dosed in a preparation. Besides the control of the dosage it is also conceivable that microprocessor unit 10 also controls electric motor 3, which allows various stirring speeds or rest times to be considered. The connection of microprocessor unit 10 with the devices, is by means of the usual control lines.

During mixing of the anticorrosive agent, dissolver disk 2 is continuously rotated at a speed of 1000 rpm. After completion, a speed of 500 rpm is set.

Depending on the composition of the anticorrosive agent, it may be necessary to temper preparation vessel 1. The second embodiment of the device for mixing and dosing shown in FIG. 2 therefore comprises a double-wall preparation vessel 1. The space resulting between the two vessel walls 21 is filled with a cooling agent. Preparation vessel 1 can thus be tempered by means of a heating/cooling unit (not shown) which is connected with supply conduit 22 and return conduit 23. The heating/cooling device should also be connected with microprocessor unit 10 for monitoring and control purposes.

Unlike FIG. 1, FIG. 2 further shows a third form of a reservoir 5c, which is suitable, in particular, for paste-like components of the anticorrosive agent. The dosage of the paste-like component is carried out by a pressing-out device 9a, which is driven by an electric motor 9b. For controlling the dosage, electric motor 9b is connected to microprocessor unit 10.

However, the exemplary embodiments shown in FIGS. 1 and 2 are only exemplary in nature. It is perfectly possible for pressing-out device 9a shown in FIG. 2 to be used in the exemplary embodiment according to FIG. 1 in addition, for example, for dosing paste-like aluminum. It is also possible to use a plurality of reservoirs 5b with corresponding worm conveyers 8 for an anticorrosive agent with a plurality of solid components. In principle, the corresponding reservoirs and dosage means should be chosen to conform to the composition of the anticorrosive agent.

A first exemplary embodiment of an application arrangement for applying the anticorrosive agent on a workpiece is shown in FIG. 3. The application arrangement comprises preparation vessel 1 already explained. The latter is used first within the above explained device for mixing and dosing. After completion of the anticorrosive agent preparation, the same preparation vessel 1 is used within the application arrangement. The use of the same preparation vessel 1 is advantageous, in particular, for a quasi-continuous operation in the industrial production process. The exchange of preparation vessel 1 between the two plants can be carried out manually, but also automatically.

To prevent the anticorrosive agent preparation showing any settling tendencies, the preparation is continuously mixed by means of a suitable stirring device, such as a spiral stirrer 42. A lid 33 closes off the preparation vessel in a pressure-tight manner. The axle passage between electric motor 3 and dissolver disk 2 is configured in a corresponding pressure-tight manner. A pressure port 32 is provided for applying pressurized air to preparation vessel 1. The anticorrosive agent is pressed out of preparation vessel 1 through a conveyer conduit 31 by applying pressurized air to pressure port 32. Conveyer conduit 31 connects preparation vessel 1 to a spray gun 34. Although not shown, a suitable filter can be arranged between preparation vessel 1 and spray gun 34. For regulating the spraying pressure, a pressure reduction regulator 35 is arranged between preparation vessel 1 and spray gun 34.

The pressure reduction regulator is controlled by a control unit 36, which is connected to a pressure measuring device 37. Control unit 36 allows each spraying pressure to be adjusted and regulates the pressure on spray gun 34 via pressure reduction regulator 35 with the help of pressure measuring device 37.

Pressure reduction regulator 35 comprises a pressure piston 38 displaceable along its longitudinal side for changing the cross section of a hose conduit 39 according to its position. For this pressure reduction regulator 35 comprises a suitable servo motor (not shown). Hose conduit 39 has an inner diameter of 4 mm.

With reference to FIG. 4, a second embodiment of the application arrangement is shown. The application arrangement shown in FIG. 4 can be distinguished from the one shown in FIG. 3 by the fact that a pump 40 is used for conveying the anti-corrosive agent from preparation vessel 1 through conveying conduit 31. Pump 40 is configured as a double-membrane pump and it conveys sucked anticorrosive agent to spray guns 34 through suitable conduits. Due to this type of conveying of the anticorrosive agent, it is not necessary to configure preparation vessel 1 and lid 33 in a pressure-resistant manner. To enable pump 40 to be operated in a continuous manner, even when spray gun 34 is not active, a return conduit 41 is provided, via which surplus anticorrosive agent is passed back into preparation vessel 1. To prevent the formation of bubbles, return conduit 41 passes back to preparation vessel 1 below the level of the anticorrosive agent present therein (below-level method). In this manner, vortexing of the anticorrosive agent within preparation vessel 1 can be achieved, so that depending on the properties of the anticorrosive agent, the stirring device can be omitted. Such an embodiment of the application arrangement is shown in FIG. 5.

The third embodiment of an application arrangement shown in FIG. 5 also has a pump 40 connected with a conveying conduit 31, as well as a return conduit 41 for returning surplus anticorrosive agent to preparation vessel 1. As shown, two spray guns 34 are present in the application arrangement. An arrangement comprising a pressure reduction regulator 35, a control unit 36 and a pressure measuring device 37 is present for each spray gun 34 for adjusting the spraying pressure at each spray gun 34. It is, however, also easily possible to arrange further spray guns 34, as shown. Pump 40 should then be chosen correspondingly so that sufficient pressure is supplied. The use of a plurality of spray guns 34 is advantageous, in particular, in industrial production lines to enable the workpiece to be coated from different directions so that uniform coating can be ensured. When a plurality of spray guns 34 is used, it is of course also possible to use the application arrangement configuration shown in FIG. 3 wherein the anticorrosive agent is fed from preparation vessel 1 by means of pressurized air.

1. An anticorrosive agent, with a first component containing zinc dust, and a second component comprising an inorganic binder and a VOC-free or VOC-conform solvent, wherein the binder comprises silicon dioxide and alkali silicate present in a mole ratio of silicon dioxide to alkali oxide of at least 4:1.

2. The anticorrosive agent according to claim 1, wherein the proportion of the first component within the overall recipe is at least 40 weight %.

3. The anticorrosive agent according to claim 1, wherein zinc dust having an average particle diameter of up to 10 μm is used.

4. The anticorrosive agent according to claim 1, wherein the first component has up to 15 weight % of an anti-settling agent relative to the overall amount of the first component.

5. The anticorrosive agent according to claim 1, wherein zinc oxide or amorphous silicon dioxide is added to the first component as an anti-settling agent.

6. The anticorrosive agent according to claim 1, wherein the second component contains sodium silicate, potassium silicate and/or lithium silicate.

7. The anticorrosive agent according to claim 1, wherein the mole ratio of silicon dioxide to alkali silicate, calculated as the ratio of silicon dioxide to alkali oxide is at least 5:1.

8. The anticorrosive agent according to claim 1, wherein the liquid component comprises a co-binder.

9. The anticorrosive agent according to claim 1, wherein methyl silicone resin or a non-saponifying acrylate are added as a co-binder.

10. The anticorrosive agent according to claim 1, wherein the proportion of the binder in the overall recipe is 3 weight % to 40 weight %.

11. The anticorrosive agent according to claim 1, wherein water and/or VOC-conform solvents are used as a solvent.

12. The anticorrosive agent according to claim 1, wherein pigments are added to the second component as a solid material or a paste in an amount of up to 20 weight relative to the overall amount of the second component.

13. The anticorrosive agent according to claim 1, wherein aluminum particles are added as pigments to the second component.

14. The anticorrosive agent according to claim 1, wherein the pigments are used as a third component of the anticorrosive agent.

15. The anticorrosive agent according to claim 1, wherein additives are added to the first and/or the second component.

16. The anticorrosive agent according to claim 1, wherein the pH value of the anticorrosive agent is between pH 6 and pH 12.

17. A VOC-conform top coat for applying on top of an anticorrosive agent according to claim 1, comprising a silicon-based binder containing silicon dioxide and alkali silicate in a mole ratio as calculated from the ratio of silicon dioxide to alkali oxide, of at least 4:1.

18. The top coat according to claim 17, wherein aluminum particles, carbon black and/or iron oxide are used as a pigment.

19. A method for coating metallic workpieces, wherein the surface of the metallic workpiece is cleaned, then coated with a VOC-free primer, after drying the primer, it is coated with an anticorrosive agent according to claim 1, and the anticorrosive agent is finally dried.

20. The method according to claim 19, wherein a top coat is applied on top of the anticorrosive agent.

21. The method according to claim 19, wherein the primer, the anticorrosive agent and the top coat are dried by means of air drying.

22. The method according to claim 19 wherein the anticorrosive agent and the top coat are dried at temperatures of not more than 120° C.

23. The method according to claim 19, wherein the metallic workpiece to be coated is cleaned by means of brushes, ultrasonic waves, an alkaline and/or solvent bath or vapor cleaning, or a combination of these cleaning steps.

24. The method according to claim 19, wherein the primer for coating the metallic workpiece is applied as a water glass solution or a co-binder of the anticorrosive agent, with wetting agents and/or corrosion inhibitors, as the case may be.

25. The method according to claim 19, wherein the primer is applied with a layer thickness of 100 nm to 3 μm.

26. A workpiece of metal, having at least a partially applied coating of an anticorrosive agent according to claim 1 applied to the surface of the workpiece.

27. The workpiece of metal according to claim 26, wherein the anticorrosive agent is applied in a layer thickness of 1 to 100 μm.

28. The workpiece according to claim 26, wherein the workpiece has a coating comprising a first layer of a primer near the surface and a second layer, applied thereon, of the anticorrosive agent.

29. The workpiece according to claim 26, wherein the workpiece is of a temperature-sensitive metal.

30. A method for producing a coating agent having at least one solid and at least one liquid component, wherein
a portion of the at least one liquid component is provided in a preparation vessel,
the at least one solid component is added,
a homogenizing phase is carried out, and
subsequently the remaining amount of the at least one liquid component is added.

31. The method for producing a coating agent according to claim 30, wherein the measuring and/or the mixing of the solid and the liquid components is automatically controlled.

32. The method for producing a coating agent according to claim 30, wherein the portion is about ⅓ of the overall amount of the liquid components.

33. The method for producing a coating agent according to claim 30, wherein during adding of the solid components and/or during the homogenizing phase, the preparation is regularly mixed.

34. The method for producing a coating agent according to claim 30, wherein a speed between 100 and 1500 rpm is set for stirring.

35. The method for producing a coating agent according to claim 30, wherein the temperature of the preparation is maintained at between 4° C. and 40° C.

36. The method for producing a coating agent according to claim 30, wherein an overpressure or partial vacuum is applied to the vessel.

37. The method for producing a coating agent according to claim 30, wherein further solid and/or liquid components are added together with or after adding the remaining amount of the at least one liquid component.

38. A device for mixing and dosing solid and liquid components of an anticorrosive agent, comprising
means for measuring the amounts of each component of the anticorrosive agent,
a preparation vessel, and
a mixing device.

39. The device for mixing according to claim 38, wherein the mixing device is a stirring device.

40. The device for mixing according to claim 38, wherein the preparation vessel is a pressure container.

41. The device for mixing according to claim 38, wherein means are provided for keeping the vessel temperature constant.

42. The device for mixing according to claim 38, wherein conveying means are provided for conveying a solid or liquid component from at least one reservoir into the preparation vessel.

43. The device for mixing according to claim 42, wherein the conveying means is a worm conveyer.

44. The device for mixing according to claim 42, wherein the conveying means is a pressing-out device.

45. The device for mixing according to claim 38, wherein control means are provided for controlling the dosage.

46. An application arrangement for applying an anticorrosive agent on a workpiece, comprising
a preparation vessel,
conveying means,
at least one pressure reduction regulator connected with the preparation vessel, and
at least one spraying device connected with the preparation vessel.

47. The application arrangement for applying anticorrosive agent according to claim 46, wherein the pressure reduction regulator is of a contact-free type.

48. The application arrangement for applying anticorrosive agent according to claim 46, wherein the preparation vessel is connected with the spraying device at least partially by means of a hose conduit, and wherein the pressure reduction regulator is configured such that the cross section of the hose conduit is at least partially variable.

49. The application arrangement for applying anticorrosive agent according to claim 46, wherein the spraying device is configured in such a way that the atomizing airflow generated in operation atomizes the anticorrosive agent outside of the spraying device.

50. The application arrangement for applying anticorrosive agent according to claim 46, wherein the preparation vessel comprises a mixing device.

51. The application arrangement for applying anticorrosive agent according to claim 46, wherein the preparation vessel is a pressurized vessel and has a device for continuously stirring the anticorrosive agent.

52. The application arrangement for applying anticorrosive agent according to claim 46, wherein
the means for pressurizing comprises a pump between the preparation vessel and the spraying device, and
a recirculating conduit is arranged between the pump and the spraying device.

53. The application arrangement for applying anticorrosive agent according to claim 46, wherein a device for mixing and dosing according to claim 38 is comprised.

54. The anticorrosive agent according to claim 1, wherein the proportion of the first component within the overall recipe is at least 60% weight.

55. The anticorrosive agent according to claim 1, wherein the proportion of the first component within the overall recipe is at least 80% weight.

56. The anticorrosive agent according to claim 1, wherein zinc dust having an average particle diameter of up to 8 μm is used.

57. The anticorrosive agent according to claim 1, wherein the first component has up to 10 weight % of an antisettling agent relative to the overall amount of the first component.

58. The anticorrosive agent according to claim 1, wherein the first component has up to 5 weight % of an antisettling agent relative to the overall amount of the first component.

59. The anticorrosive agent according to claim 1, wherein the mole ratio of silicon dioxide to alkali silicate, calculated as the ratio of silicon dioxide to alkali oxide is at least 6:1.

60. The anticorrosive agent according to claim 1, wherein the liquid component comprises a polymeric co-binder.

61. The anticorrosive agent according to claim 1, wherein the proportion of the binder in the overall recipe is 10 weight % to 20 weight %.

62. The anticorrosive agent according to claim 12, wherein the solid material or paste comprises metal particles.

63. The anticorrosive agent according to claim 1, wherein pigments are added to the second component as a solid material or a paste in an amount of up to 15 weight %.

64. The anticorrosive agent according to claim 1, wherein pigments are added to the second component as a solid material or a paste in an amount of up to 10 weight %.

65. The anticorrosive agent according to claim 1, wherein pigments are added to the second component as a solid material or a paste in an amount of up to 5 weight %.

66. The anticorrosive agent according to claim 1, wherein aluminum particles in the form of aluminum flakes are added as pigments to the second component.

67. The anticorrosive agent according to claim 1, wherein pigments are used as a third component of the anticorrosive agent in a paste-like form.

68. The anticorrosive agent according to claim 15, wherein the additives comprise lubricants or gliding agents, and combinations thereof.

69. The anticorrosive agent according to claim 16, wherein the pH value of the anticorrosive agent is between pH 8 and pH 12.

70. The top coat according to claim 17, further comprising a co-binder.

71. The top coat of claim 70, wherein the co-binder is a non-saponifying acrylate or a methyl silicone resin.

72. The top coat according to claim 71, wherein the co-binder further comprises pigments.

73. The method according to claim 20, wherein the top coat applied on top of the anticorrosive agent is a VOC-conform top coat.

74. The method according to claim 19, wherein the anticorrosive agent and the top coat are dried at temperatures of not more than 80° C.

75. The method according to claim 19, wherein the anticorrosive agent and the top coat are dried at temperatures of not more than 40° C.

76. The workpiece according to claim 27, wherein the layer thickness is 10 to 60 μm.

77. The workpiece according to claim 27, wherein the layer thickness is 20 to 40 μm.

78. The workpiece according to claim 29, wherein the temperature-sensitive metal comprises temperature-sensitive steel.
